(19) United States
(12) Patent Application Publication
(10) Pub. No.: US 2010/0241812 A1
(43) Pub. Date: Sep. 23, 2010

(54) DATA PROCESSING SYSTEM WITH A PLURALITY OF PROCESSORS, CACHE CIRCUITS AND A SHARED MEMORY

(75) Inventor: Marco Jan Gerrit Bekoou, 'S Hertogenbosch (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/682,787

(22) PCT Filed: Oct. 14, 2008
(86) PCT No.: PCT/IB2008/054216

§ 371 Date: Apr. 13, 2010

(30) Foreign Application Priority Data
Oct. 18, 2007 (EP) 07118758.7

(51) Int. Cl. G06F 12/08

(52) U.S. Cl. 711/141; 711/E12.022

(57) ABSTRACT

Data from a shared memory (12) is processed with a plurality of processing units (11). Access to a data object is controlled by execution of acquire and release instructions for the data object, and wherein each processing unit (11) comprises a processor (10) and a cache circuit (14) for caching data from the shared memory (12). Instructions to access the data object in each processor (10) are executed only between completing execution of the acquire instruction for the data object, and execution of the release instruction for the data object in the processor (10). Execution of the acquire instruction is completed only upon detection that none of the processors (10) has previously executed an acquire instruction for the data object without subsequently completing execution of a release instruction for the data object. Completion of the release instruction of each processor (10) is delayed until completion of previous write back, from the cache circuit (14) for the processor to the shared memory (12), of data from all write instructions of the processor (10) that precede the release instruction and address data in the data object. All cache lines of the cache circuit (14) that contain data from the data object is selectively invalidated, each time upon execution of the release instruction and/or the require instruction for the data object.

### FIELD OF THE INVENTION

The invention relates to a multi-processing circuit for processing data with a plurality of computer programs concurrently, using cache memories.

### BACKGROUND OF THE INVENTION

In the design of concurrently executed computer programs that use shared data, it is known to use the so-called release consistency model. This model is used in order to avoid imposing strict timing relations on the access to shared data from different programs.

When an instruction form one program reads from a storage location for shared data and an instruction from another program writes to the same location, the result of the read instruction will differ dependent on the relative time of execution of the write instruction. If such differences must be avoided, this can make the design of concurrently executing programs and multi-processing circuits very complex.

One way of avoiding this problem is use of the release consistency model. The release consistency model requires the use of synchronization instructions in programs. These instructions are typically called acquire and release instructions. When a program has to write to shared data, it must first contain an acquire instruction for the data, followed by write instructions, which in turn must be followed by the release instruction for the data. The hardware implementation of the multi-processing circuit on the other hand must be designed (a) to ensure that it does not permit execution of the acquire instruction to complete before a previous acquire instruction has been followed by execution of a completed release instruction and (b) to ensure that the release instruction completes only after the previously written data is visible to all programs.

The release consistency model may be implemented by providing semaphores (flag data) for shared data objects, to indicate for each data object whether an acquire instruction has been executed for the data object and has not yet been followed by a corresponding release instruction. Upon execution of an acquire instruction the relevant semaphore is read and set as one indivisible read modify write operation, and execution of the acquire instruction is completed only if it is found that the semaphore was not previously in a set state. Otherwise the read modify write operation is repeated. Upon execution of the release instruction the semaphore is cleared.

In addition to the shared memory multi-processors may also comprise cache memories for respective processors, for storing copies of data from the shared memory. In a multi-processor system the cache memories may give rise to consistency problems.

Typically, after data has been written by one processor the hardware has to ensure that a check is made whether copies of the written data are stored in cache memories of any other processors. If so, the written data must be updated in these cache memories or cache lines with the old data must be invalidated in these cache memories.

When programs that use the release consistency model are executed using a multi-processor with cache memories, it must be ensured that the semaphores cannot be set independently in different cache memories. Otherwise, the release consistency model would reduce the cache consistency requirements, as it suffices that cache updates occur before execution of the release instruction.

Unfortunately, the need to maintain cache consistency results in considerable circuit overhead. This overhead increases disproportionally when the number of caches increases.

### SUMMARY OF THE INVENTION

Among others it is an object to provide for a multi-processor circuit with cache memories that requires less overhead to ensure consistency.

A method of operating such a multiprocessing circuit is set forth in claim 1. In this method all cache lines of the cache circuit that contain data from the data object are invalidated, each time upon execution of the release instruction and/or the require instruction for the data object. Thus the release/acquire instructions of a program for a processor are used to avoid cache inconsistencies without requiring the use of snooping or similar overhead for maintaining cache consistency. In an embodiment cache management that does not distinguish between data from acquired data objects and other data may be used between execution of the acquire and release instruction. Thus for example, cache lines with data from the acquired data object may loaded into cache or not, just like cache lines with any other data, dependent on access to shared memory addresses. As another example, cache lines with data from the acquired data object may be removed from cache when needed to make room, just like cache lines with any other data. However, when the release instruction is executed, a distinction is made between the data, in that data from the data object is invalidated if it is in cache.

In an embodiment a write back buffer is used to send write operations from the processor to the shared memory in first in first out order. In this embodiment completion of the release instruction may be controlled by detection whether all the write operation records in the buffer have been handled. Thus, control of execution of release instructions can be realized with little overhead.

In this or another embodiment wherein a write back buffer is used to send write operations from the processor to the shared memory in first in first out order, different write back mechanisms may be used for cached data dependent on whether the cached data belongs to an acquired data object or not. Data from acquired data objects may be written via the write back buffer and other data may be written by copying back dirty cache lines when they are removed from cache. Thus, it can be avoided to write back data each time when it is written in the case of data outside acquired data objects.

### BRIEF DESCRIPTION OF THE DRAWINGS

These and other objects and advantageous aspect will become apparent from a description of exemplary embodiments using the following figures:

FIG. 1 shows a multi-processor circuit

FIGS. 2a,b show cache circuits

FIGS. 3-4 show cache circuits

### DETAILED DESCRIPTION OF EXEMPLARY EMBODIMENTS

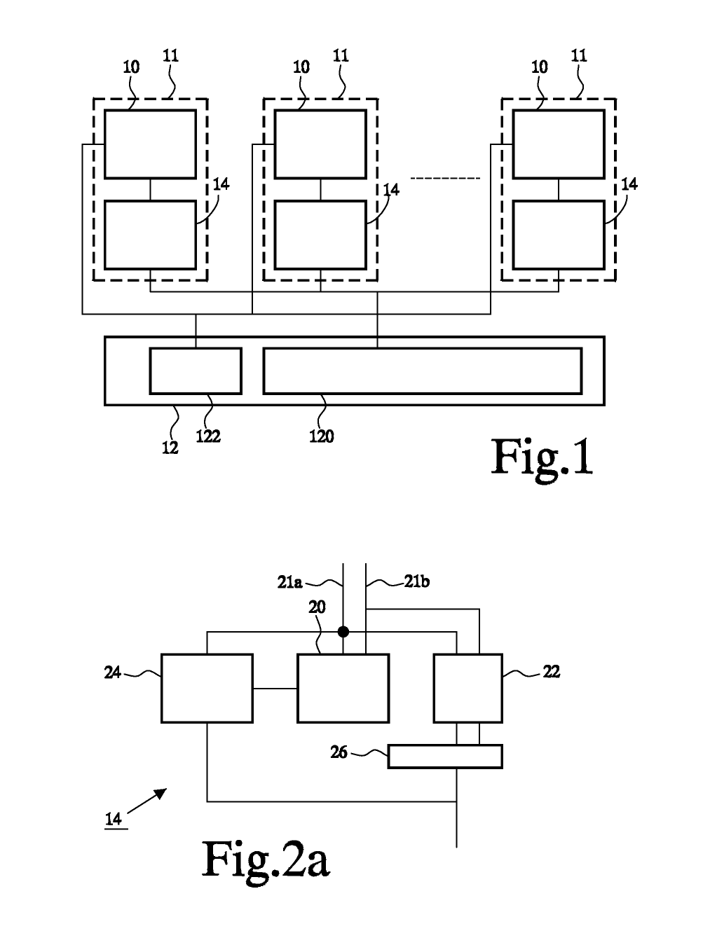

FIG. 1 shows a multi-processor circuit. The multi-processor circuit comprises a plurality of processing units 11, a shared memory 12. Each processing unit comprises a processor 10 and a cache circuit 14 coupled between the processor 10 and shared memory 12. Shared memory 12 comprises a main memory 120 and a flag memory 122.

In operation, processors 10 execute respective programs in parallel with each other. Data access by the processors 10 is managed by their associated cache circuits 14.

When the address of the accessed data corresponds to an address for which a copy of the data is stored in the cache circuit 14, the data is accessed in the cache circuit 14.

Otherwise the data is accessed in main memory 120. Copies of data for addresses in main memory 120 may be loaded into the cache circuits 14 during operation.

Typically each time a cache line is loaded, comprising data for a plurality of adjoining addresses. This may be done for example when a program accesses data from an address in a cache line, or when the data is predicted to be needed by the program.

Flag memory 122 is used to ensure release consistency. Flag memory 122 stores semaphore flags, which indicate for respective data objects in main memory 120 whether the data objects have been acquired by any processor 10. Although main memory 120 and flag memory 122 are shown as separate memory units, it should be realized that in fact main memory 120 and a flag memory 122 may correspond to different address regions in a single memory circuit. When a processor 10 executes an acquire instruction specifying a data object, it performs a read-modify-write action on the flag for that data object in flag memory 120. By read-modify-write action it is meant that no other processor 10 is allowed to access the flag memory between reading of the flag and its modification.

Once a processor 10 has successfully set a flag it proceeds to subsequent instructions, which may include write instructions with addresses corresponding to locations that store part of the data object that was indicated by the acquire instruction. Following these instructions the processor 10 executes a release instruction specifying the data object. In response to this instruction the flag for this data object is cleared, so that other processors may successfully set the flag. In an embodiment, the processor 10 responds to the release instruction by invalidating cache lines that contain copies of data from the released data object in the cache circuit 14 of the processor 10. It should be noted that these operations may be performed in addition to normal cache management. That is, apart from acquire and release instructions, cache circuit 14 may decide whether or not to load or retain data from the data object in cache memory 20, irrespective of whether it belongs to the data object or not. Thus, part or all of the data from the data object may not even be loaded into cache memory, or it may be invalidated before the release instruction for cache management reasons. But when it is still in cache memory 20 when the release instruction is executed, any cache lines containing the data are selectively invalidated in this embodiment.

It should be noted that this differentiates the data from the acquired and released data objects from other data. For cache management purposes this other data and data from acquired objects need not be distinguished: both may be loaded or dropped from the cache at will for management reasons. However, in this embodiment data from an acquired data object is special in that it is invalidated when a release instruction for the data object is executed.

It should be appreciated that in this embodiment cache management is different for cache lines that contain only private data (i.e. not-acquired data) and cache lines that contain acquired data. Cache lines with only private data may remain in cache for any time interval, until the cache management circuit selects to remove such a cache line, for example to make room for other cache data. In contrast, cache lines with data from acquired data objects are invalidated when a release instruction is executed.

In an alternative embodiment processor 10 responds to the acquire instruction for a data object by invalidating cache lines that contain copies of data from the acquired data object in the cache circuit 14 of the processor 10. It should be noted that these operations may be performed in addition to normal cache management. Invalidation of cache lines storing data of a data object in response to an acquire instruction for the data object may be implemented in addition to invalidation of cache lines of the data object in response to the release instruction, or instead of invalidation of cache lines of the data object in response to the release instruction. In each case it is ensured that modification of the data object by another processor cannot affect the validity of the data in the cache lines.

It may be considered to retain data in the cache even after a release call and to use it after an acquire call if it is still in cache, but in this case it will be necessary to invalidate the data or block its use once an acquire instruction is executed by any other processor. If the data remains in cache, the data in each cache will have to be updated in the cache according to the write actions of the other processor before the release call of the other processor is completed. Known methods of doing so include bus snooping (monitoring the memory bus to detect updates of cached data) and directory based cache coherency, wherein a directory is accessed to determine the processors that have the data in cache. By means of invalidation in response to a release instruction, the need for bus snooping or directory access is avoided.

In an embodiment access to the semaphore flags is handled by processors 10, by executing instructions to read modify write and clear flags, directed at the flag memory.

However, it should be understood that alternatively cache circuits 14 may be configured to perform part or all of these tasks. In this case cache circuits 14 may be configured to set the semaphore flags from flag memory 122 in response to a signal from the processor 10 that indicates execution of an acquire instruction and to cause the associated processor 10 to stall, at least at write instructions to the acquired data, until the flag has been successfully set. Similarly cache circuits 14 may be configured to clear the semaphore flags from flag memory 122 in response to a signal from the processor 10 that indicates execution of a release instruction.

Similarly, the invalidation of cache lines containing data from a data object may be performed under control of processor 10 or cache circuit 14. The processor hardware may be configured to respond to a release and/or acquire instruction for a data object (e.g. for a range of address values) by signaling to cache circuit 14 that cached data, if any, for this data object must be invalidated. The relevant hardware may also be part of cache circuit 14.

Alternatively, this may be controlled by software, using separate instructions to clear the flag for a data object and for invalidating cache lines for selected addresses.

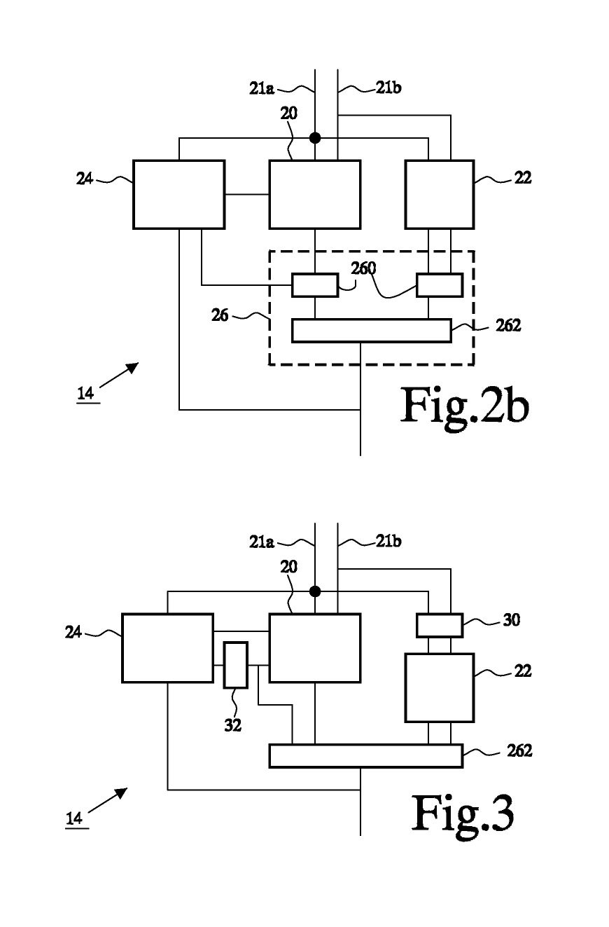

FIG. 2a shows an embodiment of cache circuit 14. The cache circuit 14 comprises a cache memory 20, a FIFO (First In First Out) buffer 22, a cache management circuit 24, and a write back circuit 26. Cache memory 20 is coupled to an address connection 21a and a data connection 21b of its associated processor (not shown). The address and data connection are also coupled to FIFO buffer 22. The address connection is coupled to cache management circuit 24. Cache management circuit 24 has outputs coupled to main shared memory (not shown), and to various units of cache circuit 14. Most of these connections have been omitted from the figure for the sake of clarity.

In operation cache memory 20 stores data and information about the shared memory address of the data. When cache circuit 14 receives an address from the associated processor cache memory 20 compares the received address with this information and cache memory 20 accesses the relevant data if it is found to be stored in cache memory. If not, cache management circuit 24 fetches the relevant data from the shared memory, for supply to the processor, optionally writing a copy of the data to cache memory 20.

Cache management circuit 24 determines shared memory addresses for which data will be written to cache memory 20, and shared memory addresses for which data will cease to be stored in cache memory 20. The determination of these addresses may be based on cache management algorithms that do not distinguish between data from acquired data objects and other data.

When the processor 10 executes a write instruction, the written data is stored in cache memory 20 if data for the address of the write instruction is cache memory 20. In parallel with writing to cache memory 20, if any, a write operation record is entered in FIFO buffer 22, each write operation record including a written data value and a write address. FIFO buffer 22 and write back circuit 26 provide for write back of data that is updated by processor 10. Write back circuit 26 takes the write operation records from FIFO buffer 22 and performs corresponding write operations to the shared memory in the order in which the write operation records are entered into FIFO buffer 22.

FIG. 2b shows an embodiment wherein cache circuit 14 writes back cache lines to shared memory if they are removed from cache memory 20 and data in the cache lines has been updated (in this case the data is said to be dirty). In this embodiment data that is part of acquired data objects and other data is treated differently in respect to how write back is executed. It may be recalled that the acquired data objects represent data that is shared with other processors, whereas the other data is considered to be private data of the processor.

When private data ceases to be stored and cache memory 20 has updated the data in response to write instructions from the processor after the data has been copied from the shared memory, cache management circuit 24 causes this data to be supplied from cache memory 20 to write back circuit 26 for writing back the data to the shared memory. It may be noted that not-acquired data may also be private data in the sense that it is data that will only be read (not written) by any processor, even if it may be read by more than one processor. Thus, acquire/release instructions may be omitted for such private data.

It should be noted that the grain size of data supplied from FIFO buffer 22 to write back circuit 26 is typically smaller than that of the data from cache memory 20. Cache memory 20 each time supplies a cache line of data (for example for 256 word address locations), whereas FIFO buffer 22 each time supplies data for a single write access, such as a single word.

In the illustrated embodiment write back circuit 26 is used to treat acquired data and private data of a program differently. Write back circuit 26 ensures that only private data is written back from cache memory 20 when a cache line is removed from cache and that shared data is written back through FIFO buffer 22. In write back circuit 26 filters 260 filter the data. Filters 260 determine whether the addresses of the data belong to a first predetermined set of addresses or not. The first predetermined set may correspond to the addresses of acquired data objects. Only write operation records with addresses in the first predetermined set are passed from FIFO buffer 22 to write control circuit 262. In contrast, only data with addresses in a second predetermined set, which is the complement of the first predetermined set, is passed from cache memory 20. Write control circuit 262 writes back the data that has been passed by the filters to the shared memory.

In a simple embodiment the first predetermined set is defined by a boundary address that separates a range of shared memory addresses where acquired objects must be stored and a range of addresses where private data may be stored. In this embodiment filters 260 may comprise a comparator to compare the addresses of the data with the boundary address. In another embodiment only a limited number of bits, possibly even only a single bit, of the addresses is used for the comparison. In an embodiment the cache circuit is configured so that the boundary address is programmable, for example in response to an instruction from the processor associated with the cache circuit 14. In this way the program of the processor may control the type of write back for different addresses. In other embodiments the first predetermined set may be defined by a memory map, which defines different regions of addresses for which the method of write back differs. Such a memory map may also be programmable from the associated processor. Use of a boundary address, for example by testing a single bit simplifies testing in the case of dynamically distributed acquired data objects, such as linked lists.

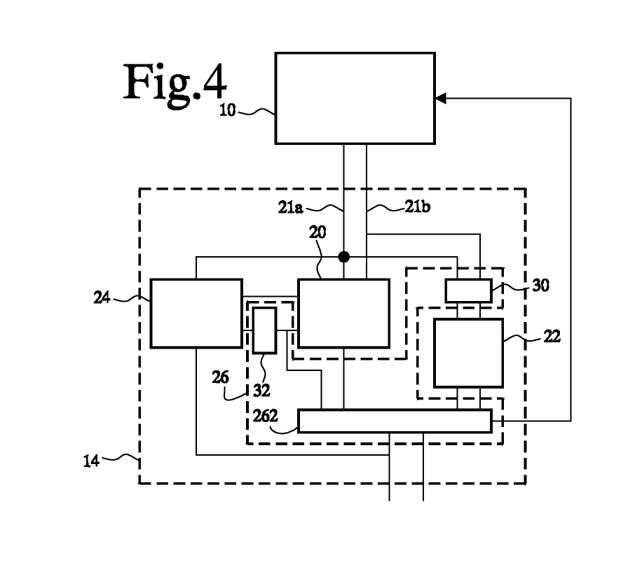

It should be noted that a similar selection may also be realized by alternative embodiments of cache circuit 14. FIG. 3 shows a number of possible variations that may be applied to the cache circuit individually or in combination. A first filter 30 has been placed between the address and data connections 21a, b of the processor and FIFO buffer 22. The first filter 30 passes only data and addresses of writes accesses with addresses in the first predetermined set. A second filter 32 is shown placed between cache management circuit 24 and write control circuit 262. Second filter 32 is activated when cache management circuit 24 signals that a cache line should be written back. Second filter 32 passes this signal only when the addresses of the cache line belong to the second predetermined set.

It should be appreciated that this embodiment is based on the observation that there is no need to write back data from the cache lines with private data before these cache lines are removed from the cache memory. Thus the number of write back operations can be reduced by filtering write operation records, preferably combined with write back of a cache line with private data when the cache line is removed from the cache memory, if the cache line has previously been updated.

FIG. 4 shows a further embodiment of a cache circuit wherein a feedback signal is provided from write control circuit 262 to processor 10. In this embodiment wherein FIFO buffer 22 is also used to buffer release operation records, for clearing semaphores in flag memory 122. Because the release operation records and write operation records are read by write back circuit in order of entry in FIFO buffer 22, the release instruction will be effected in shared memory 12 after all preceding writes have been effected. In this further embodiment, processor 10 is configured to stall after a release instruction until write control circuit 262 of cache circuit 14 generates a confirmation signal that the release instruction has been effected. Alternatively, processor 10 may be configured to proceed after a release instruction, and to stall only when executing a next acquire instruction, or more particularly an acquire instruction for the same data, if the confirmation signal has not yet been received.

In this embodiment FIFO buffer 22 is configured to buffer information to indicate which buffered operation records relate to write instructions and which relates to release instructions. Write control circuit 262 is configured to effect writing according to this information, as received from FIFO buffer 22, writing data and clearing flags. Write control circuit 262 is configured to generate the confirmation signal upon completion of writing of the flag back to processor 10.

In an alternative embodiment the release instructions may be used to set a flag memory (not shown) in cache circuit 14. In this embodiment FIFO buffer 22 is coupled to a reset input of the flag memory, to reset the flag when FIFO buffer 22 is empty. The associated processor 10 is coupled to the flag memory and configured to stall upon executing a release instruction until the flag memory is cleared. Alternatively, the associated processor 10 may be configured to proceed to stall only when it executes a next acquire instruction, or more particularly an acquire instruction for the same data object, if the flag memory is still set.

In an embodiment different data objects may be acquired by different processors at the same time. In this case, acquire and release instructions preferable specify the data object to which they apply (and thereby their semaphore flags). Because of the invalidation accompanying release and/or acquire instructions for the data objects any inconsistencies between different caches are prevented. Optionally, in this case, the write operation records for different data objects may be buffered in different, parallel FIFO buffers 22, as the release instruction for a data object may be completed if the previous write operations for that data object have been completed, no matter the status of write operations to other acquired data objects. In this case write control circuit 262 may be configured to give priority to handing of write operation records from the FIFO buffer 22 for which a release instruction has been received.

When the data from different acquired data objects may be stored in the same cache line and cache circuit 14 is configured to invalidate cache lines that contain data from a data object upon executing an acquire instruction for that object, this prevents inconsistencies when such cache lines are already in cache memory for accessing another, previously acquired data object. Furthermore, apart from use of a plurality of data objects, invalidation of cache lines for a data object upon executing an acquire instruction for the data object has the advantage that it is more robust against abnormal program termination, without release of data objects or changes in the memory regions where objects are stored. Invalidation of cache lines for a data object upon executing a release instruction has the advantage that it prevents inconsistencies if subsequent use of the data object without acquire instruction is permitted at some stage of processing.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of processing data from a shared memory with a plurality of processing units, wherein access to a data object is controlled by execution of acquire and release instructions for the data object, and wherein each processing unit includes a processor and a cache circuit for caching data from the shared memory, the method comprising:
executing instructions to access the data object in each processor only between completing execution of the acquire instruction for the data object and executing the release instruction for the data object in the processor;
completing the acquire instruction only upon detection that none of the processors has previously executed an acquire instruction for the data object without subsequently completing execution of a release instruction for the data object;
delaying completion of the release instruction of each processor until completion of previous write back, from the cache circuit for the processor to the shared memory, of data from all write instructions of the processor that precede the release instruction and address data in the data object;
selectively invalidating all cache lines of the cache circuit that contain data from the data object, each time upon execution of at least one of the release instruction and the require instruction for the data object.

2. A method according to claim 1, further comprising:
buffering, in each processing unit, write operation records for write instructions performed in the processing unit;
performing write operations to the shared memory in accordance with the buffered write operation records in an order in which the processing unit has executed the write instructions; and
detecting whether all the write operation records for write instructions that the processing unit has executed preceding the release instruction have been used to perform write operations to the shared memory, and completing the release instruction only after said detecting.

3. A method according to claim 1, further comprising:
buffering, in each processing unit, write operation records for write instructions performed in the processing unit;
performing write operations to the shared memory in accordance with the buffered write operation records selectively for write instructions performed in the processing unit to data in the data object; and
performing write operations to the shared memory in accordance with data stored in cache lines of the cache circuit, when the cache lines are removed from the cache circuit, selectively for cache lines that do not store data from the data object.

4. A method according to claim 1, further comprising performing cache management of cached data during execution of instructions of the processor between the acquire instruction and the release instruction irrespective of whether the cached data belongs to a data object that has been acquired by a previous acquire instruction or not.

5. A data processing system, comprising:
a shared memory, including a flag memory configured to store a semaphore flag for indicating whether a data object has been acquired;
a plurality of processing units, each comprising a processor, each processor (configured to access a data object in the shared memory only between completing execution of an acquire instruction to set the semaphore flag and before executing a release instruction to clear the semaphore flag; and
each processing unit including a cache circuit for caching data from the shared memory, wherein at least one of the processing units is configured to invalidate all cache lines containing data from the data object in connection with execution of at least one of the release instruction and the require instruction for the data object.

6. A data processing system according to claim 5, wherein the cache circuit of said at least one of the processing units comprises:
an addressable cache memory coupled to the processor of the cache circuit of the at least one of the processing units;
a buffer coupled to the processor of the at least one of the processing units, for buffering write operation records for write instructions executed by the processor; and
a write control circuit for effecting the write operations to the shared memory according to the write operation records, in an order in which the write operation records are received by said buffer;
wherein said at least one of the processing units is configured to delay clearing of the semaphore flag after the release instruction until it has determined that all write operation records that have been issued preceding a start of execution of the release instruction have been passed to the shared memory from the buffer.

7. A data processing system according to claim 5, wherein the buffer is configured to buffer release operation records for release instructions executed by the processor of said at least one of the processing units, the write control circuit being configured to read the write operation records and the release operation record in an order in which these records have been buffered in said buffer, and to enable the processor to complete execution of the release instruction upon reading the release operation record, after effecting write operations according write operation records that have been issued preceding a start of execution of the release instruction.

8. A data processing system according to claim 7, wherein the write control circuit is configured to clear the semaphore flag in response to the release operation record.

9. A data processing system according to claim 5, wherein the cache circuit of said at least one of the processing units comprises:
an addressable cache memory coupled to the processor of the at least one of the processing units that contains the cache circuit;
a buffer coupled to the processor of the at least one of the processing units, for buffering write operation records for write instructions issued from the processor;
a write control circuit for effecting the write operations to the shared memory according to the write operation records, in an order in which the write operation records are buffered in said buffer;
wherein the write control circuit is configured to perform write operations to the shared memory in accordance with the buffered write operation records selectively for write instructions performed in the processing unit to data in the data object; and to perform write operations to the shared memory (12) in accordance with data stored in cache lines of the cache circuit, when the cache lines are removed from the cache circuit, selectively for cache lines that do not store data from the data object.

10. A data processing system according to claim 9, wherein the write control circuit is configured to detect whether a write operation is performed for the data object; and whether cache lines do not store data from the data object respectively, both based on an address in the write operation and an address of data in the cache line.

11. A data processing system according to claim 9, further comprising a filter configured to block entry of write operation records into the buffer for write instructions that do not address data in the data object.
